(19) United States
(12) Patent Application Publication
(10) Pub. No.: US 2025/0077308 A1
(43) Pub. Date: Mar. 6, 2025

(54) DISTRIBUTED COMPUTING METHOD, SYSTEM AND DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Ruidong YAN, Suzhou, Jiangsu (CN); Lu LIU, Suzhou, Jiangsu (CN); Liang JIN, Suzhou, Jiangsu (CN); Cong XU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/724,126

(22) PCT Filed: Sep. 29, 2022
(86) PCT No.: PCT/CN2022/122792

§ 371 Date: Jun. 25, 2024

(30) Foreign Application Priority Data
Jun. 15, 2022 (CN) 202210671289.4

(51) Int. Cl. G06F 9/52; G06F 9/50

(52) U.S. Cl. CPC G06F 9/52; G06F 9/5083

(57) ABSTRACT

The present disclosure relates to the field of data processing. Provided is a distributed computing method, comprising: acquiring a data computing task; splitting the data computing task to obtain subtasks, deploying the subtasks to computing nodes, and configuring a parallel mode for each of the computing nodes in a distributed training universal frame; configuring a connection manner and a communication synchronization manner between the computing nodes; optimizing information synchronization efficiency for the computing nodes by using a gradient optimization algorithm or a non-gradient optimization algorithm; and aggregating intermediate results generated by the computing nodes, and outputting a corresponding final computing result. The present disclosure may reduce restriction from a hardware system, and by means of effective distributed algorithm design, a subtask training space is reduced, and the model training time is reduced, thereby effectively improving the accuracy of model training, and reducing the storage overhead of gradient and model parameter variables. Further provided are a distributed computing system, a distributed computing device, and a non-transitory computer-readable storage medium, which have the above beneficial effects.

### CROSS-REFERENCE TO RELATED APPLICATION

The present application is a National Stage Application of PCT International Application No.: PCT/CN2022/122792 filed on Sep. 29, 2022, which claims priority to Chinese Patent Application 202210671289.4, filed in the China National Intellectual Property Administration on Jun. 15, 2022, the disclosure of which is incorporated herein by reference in its entirety.

### TECHNICAL FIELD

The present disclosure relates to the field of data processing, and in particular, to a distributed computing method, system and device, and a storage medium.

### BACKGROUND

In recent years, significant advances have been made in big data, machine learning, deep learning, high-performance computing, and Internet technologies, which promote development in fields such as computer vision, natural language processing, language recognition and autonomous driving, and have a great impact on academia and industry. At present, massive data, and models with ultra-large parameter scales, such as GPT-3 and Bert, generated in various fields impose higher requirements on performance and computational resources of an artificial intelligent training method. In order to solve the problem of effective training of a large model on a large data set, distributed training technology gradually attracts extensive attention of academic and industrial researchers. The core of distributed training uses the concept of “divide and conquer”. Firstly, a large model or a large data set to be trained is split in a model parallel mode, a data parallel mode or a hybrid parallel mode; then, the split small-scale data or models are separately trained to obtain one or more local training results; and finally, all the local training results are aggregated in a certain manner, and a global training result is outputted. Currently, researchers conduct research on distributed training methods at both software and hardware levels: at the software level, improvement measures and training strategies for various optimizers and optimization operators are proposed; and at a hardware system platform level, an accelerated training method such as a distributed computing system based on hybrid heterogeneous computation is designed.

Although there are a series of existing methods and apparatuses for solving distributed training, the following problems still exist. When a data set or a model is split, when the splitting is improper, there are many problems, such as the split sub-data sets or models are difficult to be suitable for computing nodes, communication efficiency between computing nodes is low, and an aggregation effect of intermediate results generated by different computing nodes is poor.

### SUMMARY

The embodiments of the present disclosure provide a distributed computing system, a distributed computing method, a distributed computing device, and a non-transitory computer-readable storage medium, which may optimize processes such as task splitting and communication manners in a distributed computing process, thereby improving a distributed computing effect.

In order to solve the described technical problems, some embodiments of the present disclosure provide a distributed computing method, and the specific technical solution is as follows:
acquiring a data computing task;
splitting the data computing task to obtain subtasks, and deploying the subtasks to computing nodes, and configuring a parallel mode for each of the computing nodes in a distributed training universal frame;
configuring a connection manner and a communication synchronization manner between the computing nodes;
optimizing information synchronization efficiency for the computing nodes by using a gradient optimization algorithm or a non-gradient optimization algorithm; and
aggregating intermediate results generated by the computing nodes, and outputting a final computing result corresponding to the data computing task.

Optionally, the parallel mode includes a data parallel mode, a model parallel mode, and a hybrid parallel mode, wherein the data parallel mode includes sample-based data parallelism and sample dimension-based data parallelism.

Optionally, when the sample-based data parallelism is adopted, deploying the subtasks to the computing nodes includes:
deploying each of the subtasks to the computing nodes by means of random sampling with replacement and local shuffling sampling.

Optionally, when the sample dimension-based data parallelism is adopted, and the subtasks include one or more dimensions of attributes or features, then deploying the subtasks to the computing nodes includes:
dividing the subtasks according to attributes or features to obtain task samples; and
allocating the task samples to the computing nodes corresponding to the task samples.

Optionally, when the parallel mode is the model parallel mode, the method further includes:
horizontally splitting a distributed computing model or vertically splitting a distributed computing model to adapt to the subtasks.

Optionally, configuring the connection manner and the communication synchronization manner between the computing nodes includes:
determining whether the data computing task includes a specified connection manner;
when the data computing task includes a specified connection manner, constructing a distributed computing system in the specified connection manner when the data computing task includes the specified connection manner, wherein the specified connection manner includes either a centralized architecture or a decentralized architecture; and
parsing the data computing task to obtain the communication synchronization manner, and configuring the communication synchronization manner between nodes in the distributed computing system according to the communication synchronization manner.

Optionally, when the specified connection manner is a centralized architecture, constructing the distributed computing system in the specified connection manner includes:
determining workers consisting of the computing nodes and a server consisting of one or a group of server nodes,
wherein the workers are used for completing a local training task, communicating with the server through a client interface so as to acquire a latest global model parameter, and sending local parameters of the workers to the server; and the server is used for aggregating the local parameters sent by each of the workers, and updating the global model parameter by using ADD or SUM operations.

Optionally, when the specified connection manner is a decentralized architecture, constructing the distributed computing system in the specified connection manner includes:
determining workers consisting of the computing nodes;
wherein information exchange between the workers is performed by using a Reduce architecture or a Gossip architecture, and distributed the computing system is constructed by using the Reduce architecture or the Gossip architecture.

Optionally, when the distributed computing system adopts the Reduce architecture, each of the workers communicates with all other workers comprised in the workers and transmits local information to all the other workers in a broadcast manner.

Optionally, when the distributed computing system adopts the Gossip architecture, each of the workers communicates with its neighboring workers comprised in the workers.

Optionally, when the communication synchronization manner is synchronous communication, configuring the communication synchronization manner between the nodes in the distributed computing system according to the communication synchronization manner includes:
configuring the communication synchronization manner between the nodes in the distributed computing system according to synchronous communication, wherein when any computing node in the distributed training system completes the current round of iteration, after waiting for other computing nodes to complete the current round of iteration tasks corresponding to the other computing nodes, all the computing nodes start to process the next round of training iteration tasks.

Optionally, when the communication synchronization manner is asynchronous communication, configuring the communication synchronization manner between the nodes in the distributed computing system according to the communication synchronization manner includes:
configuring the communication synchronization manner between the nodes in the distributed computing system according to asynchronous communication, wherein when any computing node in the distributed training system completes the current round of iteration, the computing node continues to process the next round of training iteration tasks.

Optionally, aggregating the intermediate results generated by the computing nodes, and outputting the final computing result corresponding to the data computing task includes:
aggregating, by using an ADD-SUM aggregation logic or an integrated aggregation logic, the intermediate results generated by the computing nodes, and outputting the final computing result corresponding to the data computing task,
wherein the ADD-SUM aggregation includes a full aggregation logic and a partial aggregation logic, the full aggregation logic is used for assigning different weights to different computing nodes, and calculating a weighted sum of the intermediate results generated by all the computing nodes.

Some embodiments of the present disclosure further provide a non-transitory computer-readable storage medium, wherein the non-transitory computer-readable storage medium stores a computer program, and the computer program, when executed by a processor, implements the operations of the described method.

Some embodiments of the present disclosure further provide a server, including a memory and a processor, wherein the memory stores a computer program, and when the processor invokes the computer program in the memory, the operations of the described method are implemented.

Some embodiments of the present disclosure further provide a distributed computing method, including: acquiring a data computing task; splitting the data computing task to obtain subtasks, deploying the subtasks to computing nodes, and configuring a parallel mode for each of the computing nodes in a distributed training universal frame; configuring a connection manner and a communication synchronization manner between the computing nodes; optimizing information synchronization efficiency for the computing nodes by using a gradient optimization algorithm or a non-gradient optimization algorithm; and aggregating intermediate results generated by the computing nodes, and outputting a final computing result corresponding to the data computing task.

In the embodiments of the present disclosure, after a data computing task is received, the data computing task is first split to obtain subtasks, thereby deploying the subtasks to the computing nodes; and the configuration of a parallel mode, a connection manner and a communication synchronization manner in a distributed computing system is executed, and optimization is performed on information synchronization between the computing nodes, so as to execute distributed computing, thereby reducing restriction from a hardware system. By means of effective distributed algorithm design, factors affecting the training of a deep learning model are developed, an accurate and reliable distributed accelerated computing rule is established, a subtask training space is reduced, and the model training time is reduced, thereby effectively improving the accuracy of model training, and reducing the storage overhead of gradient and model parameter variables.

Some embodiments of the present disclosure further provide a distributed computing system, a distributed computing device, and a non-transitory computer-readable storage medium, which have the foregoing beneficial effects, and are not further described herein.

### BRIEF DESCRIPTION OF THE DRAWINGS

In order to describe the technical solutions in the embodiments of the disclosure or in the related art more clearly, hereinafter, accompanying drawings requiring to be configured for describing the embodiments or the related art are introduced briefly. Apparently, the accompanying drawings in the following description merely relate to the embodiments of the disclosure, and for a person having ordinary skill in the art, other accompanying drawings may also be obtained according to the provided accompanying drawings without involving any inventive effort.

FIG. 1 is a flow chart of a distributed computing method according to some embodiments of the present disclosure;

FIG. 2 is a schematic diagram of a centralized architecture according to some embodiments of the present disclosure;

FIG. 3 is a schematic diagram of a decentralized architecture of a Reduce architecture according to some embodiments of the present disclosure;

FIG. 4 is a schematic diagram of a decentralized architecture of a Gossip architecture according to some embodiments of the present disclosure;

FIG. 5 is a schematic structural diagram of a distributed computing system according to some embodiments of the present disclosure; and

FIG. 6 is a schematic structural diagram of a distributed computing device according to some embodiments of the present disclosure.

### DETAILED DESCRIPTION OF THE EMBODIMENTS

In order to make objects, technical solutions and advantages of the embodiments of the present disclosure clearer, hereinafter, the technical solutions in the embodiments of the present disclosure will be described clearly and completely with reference to the accompanying drawings of the embodiments of the present disclosure. Obviously, the embodiments as described are a part of the embodiments of the present disclosure, not all of the embodiments. All other embodiments obtained by a person skilled in the art based on the embodiments of the application without any inventive effort shall all fall within the scope of protection of the disclosure.

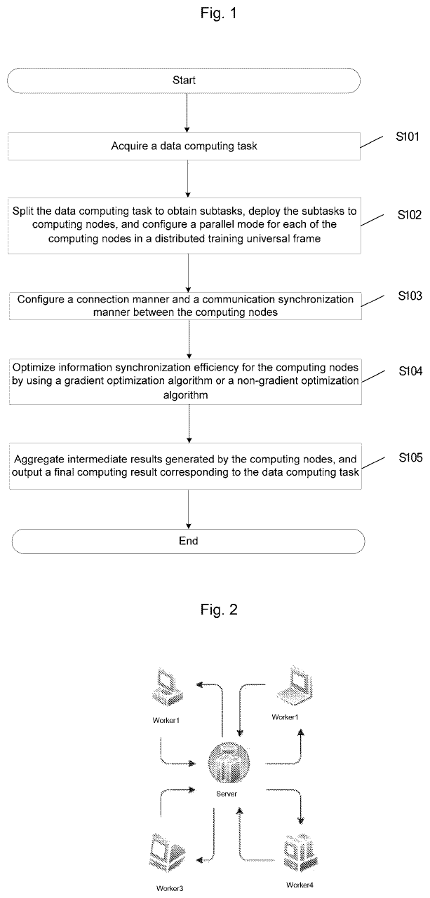

Referring to FIG. 1, FIG. 1 is a flow chart of a distributed computing method according to some embodiments of the present disclosure. The method includes:

At operation S101: A data computing task is acquired.

This operation aims to acquire a data computing task, and no limitation is provided herein on how to acquire the data computing task. In practical applications of the embodiments of the present disclosure, a data computing task sent by a cloud or another distributed computing device may be received through a network or a data link. The specific content of the data computing task is not limited herein, and may include task content for which data computation needs to be performed, available computing methods, and the like, so as to perform computation by using an adaptive distributed computing system or a distributed computing method in the embodiments of the present disclosure.

At operation S102: The data computing task is split to obtain subtasks, the subtasks are deployed to computing nodes, and a parallel mode for each of the computing nodes in a distributed training universal frame is configured.

This operation aims to split a data computing task. As the data computing task is probably a task involving a huge amount of computation and data, in this operation, the data computing task may be split first to obtain subtasks. The specific splitting method is not limited herein. Generally, task splitting may be performed in a manner that a data computing task is adapted to the number or performance of computing nodes in a distributed computing system.

After the subtasks are obtained by splitting, the subtasks are deployed to the computing nodes, and the parallel mode for each of the computing nodes is configured. The parallel mode is not limited herein, and may include, but is not limited to, data parallel, model parallel, hybrid parallel, and the like. Certainly, other parallel modes may also be used, which are not limited herein one by one.

The parallel mode may include a data parallel mode, a model parallel mode, and a hybrid parallel mode, and the data parallel mode includes sample-based data parallelism and sample dimension-based data parallelism.

When the sample-based data parallelism is adopted, when this operation is executed, each of the subtasks may be deployed to the computing nodes by means of random sampling with replacement and local shuffling sampling.

When the sample dimension-based data parallelism is adopted, and the subtasks include one or more dimensions of attributes or features, when this operation is executed, the subtasks may be divided according to the attributes or the features to obtain task samples, and then the task samples are allocated to corresponding computing nodes.

In addition, when the parallel mode is the model parallel mode, a distributed computing model may be horizontally split or a distributed computing model may be vertically split, so as to adapt to the subtasks. For example, a neural network model may be horizontally split or vertically split according to different splitting method.

It should be noted that, when distributed computation is performed, a corresponding distributed computing system needs to be constructed, so as to complete the distributed computation. The distributed training universal frame in this operation is a necessary infrastructure for constructing a distributed computing system. A person skilled in the art may pre-configure content of a basic frame required by the distributed computation, so as to adapt to different distributed computing requirements.

At operation S103: A connection manner and a communication synchronization manner between the computing nodes are configured.

In this operation, based on the previous operation, a connection manner and a communication synchronization manner between the computing nodes in the distributed computing system are further configured, and the connection manner refers to the communication topology architecture of the computing nodes in the distributed computing system, and the communication manner between the computing nodes in the communication topology architecture.

As a preferred execution manner of this operation, this operation may be executed according to the following operations:

At operation S1031: Whether the data computing task includes a specified connection manner is determined. When the data computing task includes the specified connection manner, operation S1032 is proceeded to. When the data computing task does not include a specified connection manner, a connection manner between the computing nodes is configured in a default connection manner.

At operation S1032: A distributed computing system is constructed by using a specified connection manner. The specified connection manner including either a centralized architecture or a decentralized architecture.

At operation S1033: The data computing task is parsed to obtain the communication synchronization manner, and the communication synchronization manner between nodes in the distributed computing system is configured according to the communication synchronization manner.

When the connection manner is specified in the data computing task, the connection manner of the computing nodes in the distributed computing system is configured according to the specified connection manner in the data computing task, and when the connection manner is not specified in the data computing task, the configuration is performed according to a default connection manner, which is not limited herein, and may be set by a person skilled in the art in a customized manner.

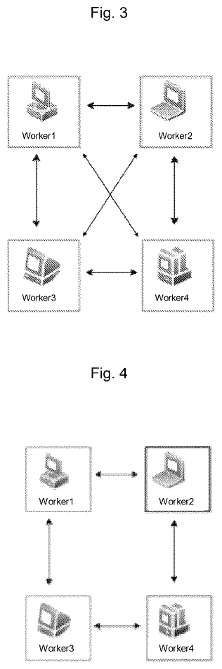

Referring to FIG. 2 to FIG. 4, wherein FIG. 2 is a schematic diagram of a centralized architecture according to some embodiments of the present disclosure, FIG. 3 is a schematic diagram of a decentralized architecture of a Reduce architecture according to some embodiments of the present disclosure, and FIG. 4 is a schematic diagram of a decentralized architecture of a Gossip architecture according to some embodiments of the present disclosure. The centralized architecture and the decentralized architecture are respectively described below.

When the specified connection manner is a centralized architecture, when constructing a distributed computing system in the specified connection manner, workers consisting of the computing nodes and a server consisting of one or a group of server nodes may be determined first. The workers are used for completing a local training task, communicating with the server through a client interface so as to acquire a latest global model parameter, and sending local parameters of the workers to the server. The server is used for aggregating the local parameters sent by each of the workers, and updating the global model parameter by using ADD or SUM operations.

When the specified connection manner is a decentralized architecture, only workers consisting of computing nodes need to be determined, and information exchange between the workers is performed by using a Reduce architecture or a Gossip architecture, and the distributed computing system is constructed by using the Reduce architecture or the Gossip architecture.

When the distributed computing system adopts the Reduce architecture, referring to FIG. 3, each of the workers communicates with all other workers included in the workers and transmits local information to all the other workers in a broadcast manner. When the distributed computing system adopts the Gossip architecture, referring to FIG. 4, each of the workers only communicates its neighboring workers included in the workers.

The communication synchronization manner includes synchronous communication and asynchronous communication. When synchronous communication is adopted, a communication synchronization manner between nodes in the distributed computing system may be configured according to synchronous communication, wherein when any computing node in the distributed training system completes the current round of iteration, after waiting for other computing nodes to complete the current round of iteration tasks corresponding to the other computing nodes, all the computing nodes start to process the next round of training iteration tasks.

When asynchronous communication is adopted, a communication synchronization manner between nodes in the distributed computing system may be configured according to the asynchronous communication. During asynchronous communication, wherein when any computing node in the distributed training system completes the current round of iteration, the next round of training iteration tasks may be directly processed continuously.

At operation S104: Information synchronization efficiency is optimized for the computing nodes by using a gradient optimization algorithm or a non-gradient optimization algorithm.

In order to further improve the distributed computing efficiency, information synchronization efficiency may be optimized for the computing nodes by using a gradient optimization algorithm or a non-gradient optimization algorithm, i.e. information synchronization between the computing nodes is further improved, thereby ensuring that the next round of iteration computation may be executed as soon as possible.

The optimization problem in deep learning adopting a distributed training policy may be generally described as the following optimization problem:

$${min}_{w ∈ {R}^{d}} \{ f ( w ) = \frac{1}{n} {\sum }_{\text{?}} {f}_{i} ( w ) \}$$

$$\text{?} \text{indicates text missing or illegible when filed}$$

where w∈R^{d} represents a d-dimensional parameter vector, f(w) is a global function, each local function fᵢ(w) is smooth, [n]={1, 2, . . . , n}, n represents the number of distributed computing nodes. Representative examples of the described problem include a classification problem in logistic regression, a minimization problem of energy consumption in a multi-agent system, etc.

In order to solve the described problem, a first-order optimization algorithm, such as a Gradient Descent (GD) algorithm, plays a fundamental role. The core iteration operation of the GD algorithm is as follows:

$${w}_{t + 1} = {w}_{t} - η * \frac{1}{n} {\sum }_{{i}_{t}}^{n} ∇ {f}_{{i}_{t}} ( {w}_{t} )$$

where η represents a learning rate, ∇fᵢ_{ₜ}(wₜ) represents a stochastic gradient of t based on parameter wₜ and sample iₜ in iterations. However, GD requires traversing the full dataset and computing the full gradient in each iteration. When the dataset is very large in scale, this will result in huge computation overheads. In order to avoid the problem of computing the full gradient, a Stochastic Gradient Descent (SGD) algorithm may further be used, and the core iteration process thereof is as follows:

$${w}_{t + 1} = {w}_{t} - η * \frac{1}{\vert {B}_{t} \vert} {\sum }_{{i}_{t} ∈ {B}_{t}} ∇ {f}_{{i}_{t}} ( {w}_{t} ) .$$

In contrast to the GD algorithm, SGD only requires computing a stochastic gradient of one sample in each iteration, and the time overhead for computing the gradient is reduced from O(m) to O(1), where m represents the number of samples of the dataset. However, as SGD uses a single sample to stochastically replace the full gradient, an additional “bias” is generated, which is defined as a “variance” in the art. The presence of the variance may slow the convergence speed of the SGD algorithm. In order to solve this problem, a Mini-Batch SGD algorithm is proposed, and the core iteration rule thereof is as follows:

$${w}_{t + 1} = {w}_{t} - η * ∇ {f}_{{i}_{t}} ( {w}_{t} )$$

where Bₜ is a set of samples consisting of a plurality of random samples.

The update formula of an order gradient optimization algorithm, such as Natural Gradient Descent (NGD) method, is as follows:

$${w}_{t + 1} = {w}_{t} - η * {F}^{- 1} ∇ {f}_{{i}_{t}} ( {w}_{t} )$$

In the above formula, F is a Fisher information matrix.

The above is a description of some of optimization algorithms. In a specific application of the present disclosure, for the intermediate results obtained by the computing nodes processing the subtasks, before a final computing result is generated, a gradient optimization algorithm or a non-gradient optimization algorithm may be used to perform optimization computing on the intermediate results as data to be processed, thereby ensuring fast aggregation.

In addition, gradient computing or communication accounts for 94% or more of the total duration of the GPU training, seriously limiting the training efficiency. Therefore, it is crucial to improve the communication efficiency of the distributed training. Generally, reducing communication traffic may be employed to improve the communication efficiency. This operation proposes an improved 1-bit compression optimization technique. The original 1-bit compression optimization technique and the improved 1-bit compression technique are introduced below respectively.

The original 1-bit compression technique is defined as:

C[*] represents compression operation computing, ∥·∥₁ represents the L1 norm of a vector, x∈R^{d} represents a d-dimensional real-number vector, sign(x) represents the sign of vector x, then 1-bit compression operation is performed on the vector x:

$$C [ x ] = \frac{{‖ x ‖}_{1}}{d} \cdot sign ( x )$$

Although the above compression process may reduce the communication traffic, an error code may occur in some cases. For example, for vector x=[1,−2,3] and vector y=[1,2,3]:

$$\begin{matrix}C [ x ] = ( \vert 1 \vert + \vert - 2 \vert + \vert 3 \vert ) / 3 * ( + ) ; \\ C [ y ] = ( \vert 1 \vert + \vert 2 \vert + \vert 3 \vert ) / 3 * ( + ) .\end{matrix}$$

It may be seen that the compression results of the two vectors are the same. In other words, after different vectors are subjected to original 1-bit compression, the results are exactly the same, and obviously, such compression may generate an error code. Conversely, the goal of compression should be making as differentiated as possible. To this end, this operation may adopt the improved 1-bit compression technique to avoid the described problem.

The improved 1-bit compression technique is as follows:

$$\hat{C} [ x ] = λ \cdot \frac{{‖ x ‖}_{2}}{d} \cdot sign ( x ) \qquad \text{(*} )$$

$${( \hat{C} [ x ] - x )}^{2} \leq μ \qquad \text{(*} \text{*)}$$

The formula (*) adopts the L2 norm of a vector, and introduces a scaling factor λ (usually 0<λ<1), so as to solve the error code problem of the original 1-bit compression method. The formula (**) mainly aims to limit the difference between compressed data Ĉ[x] and original data x to not exceed a set constant μ, so as to ensure the compression precision as far as possible.

Therefore, although the durations required for the computing nodes to compute to obtain the intermediate results are different as different computing nodes are limited by their own hardware, and the task difficulty and amount of data of the subtasks to be processed, etc., gradient optimization or non-gradient optimization may be performed on the output intermediate results to compress the intermediate results obtained by the computing nodes, such that the time required for the computing nodes to execute intermediate result synchronization is relatively centralized, avoiding the situation that the duration required for the whole system to obtain the intermediate results is prolonged and the information synchronization efficiency between nodes are further affected due to the intermediate results with long computing duration needing long synchronization time.

At operation S105: Intermediate results generated by the computing nodes are aggregated, and a final computing result corresponding to the data computing task is outputted.

After the target round of iteration computation is completed, the final computing result may be outputted by aggregating the intermediate results generated by the computing nodes.

As an execution manner, in this operation, by using an ADD-SUM aggregation logic or an integrated aggregation logic, the intermediate results generated by the computing nodes are aggregated, and the final computing result corresponding to the data computing task is outputted. The ADD-SUM aggregation includes a full aggregation logic and a partial aggregation logic. The full aggregation logic is used for assigning different weights to different computing nodes, and calculating a weighted sum of the intermediate results generated by all the computing nodes.

In the embodiments of the present disclosure, after a data computing task is received, the data computing task is first split to obtain subtasks, thereby deploying the subtasks to the computing nodes; the configuration of a parallel mode, a connection manner and a communication synchronization manner in a distributed computing system is executed, and optimization is performed on information synchronization between the computing nodes, so as to execute distributed computing, thereby reducing restriction from a hardware system. By means of effective distributed algorithm design, factors affecting the training of a deep learning model are developed, an accurate and reliable distributed accelerated computing rule is established, a subtask training space is reduced, and the model training time is reduced, thereby effectively improving the accuracy of model training, and reducing the storage overhead of gradient and model parameter variables.

Please refer to FIG. 5, FIG. 5 is a schematic structural diagram of a distributed computing system according to some embodiments of the present disclosure. Compared with the distributed computing method according to the foregoing embodiment, the distributed computing system includes:
a division component, configured to split a data computing task to obtain subtasks, deploy the subtasks to computing nodes, and configure a parallel mode for each of the computing nodes in a distributed training universal frame;
a communication component, configured to configure a connection manner and a communication synchronization manner between the computing nodes;
an algorithm optimization component, configured to optimize information synchronization efficiency for the computing nodes by using a gradient optimization algorithm or a non-gradient optimization algorithm; and
an aggregation component, configured to aggregate intermediate results generated by the computing nodes, and output a final computing result corresponding to the data computing task.

The distributed computing system according to the embodiments of the present disclosure mainly includes the division component, the communication component, the algorithm optimization component, and the aggregation component. The four components are complementary to each other, and play different roles in the distributed computing system. The four components are described one by one as follows:

The division component corresponds to operation S102 in the foregoing embodiment, and is mainly configured to divide a data computing task that needs to be executed. The data computing task may be a data set or a data model, so as to obtain a corresponding sub-data set or sub-model by means of splitting. For ease of understanding, the present embodiment is described uniformly in terms of subtasks. In the splitting process, different splitting policies may be used. In this embodiment, one or more parallel modes of the computing nodes are provided, and the splitting policy may use a corresponding splitting manner according to the parallel mode used. The parallel mode may include a data parallel mode, a model parallel mode and a hybrid parallel mode, and the data parallel mode may further include sample-based data parallelism and sample dimension-based data parallelism.

For the data parallel mode, data parallelism depends on the subdivision of the data set by multiple computing nodes in a parallel computing environment, to achieve segmented computation. The data parallel algorithm focuses on distributing data on different parallel computing nodes, and the computing nodes execute the same computing model. The data parallel mode is divided into sample-based data parallelism and sample dimension-based data parallelism according to different splitting policies of the data set. Sample-based data parallelism: assuming that a distributed training system data set includes m data samples and n computing nodes, the m data samples are distributed to the n computing nodes in two modes: bootstrap sampling and local (global) shuffling sampling. Sample dimension-based data parallelism: given that the data set contains m samples and each sample has a d-dimension attribute or feature, the distributed training system includes n compute nodes. From a sample attribute dimension, the sample dimension-based data parallelism involves splitting m samples according to different attributes, and allocating split sample subsets to corresponding computing nodes.

For the model parallel mode, when a data computing task is too large and storage may not be implemented in a stand-alone manner, a model needs to be effectively split, so that a training task becomes feasible. The model parallelism involves splitting the model parameters into multiple sub-models, and allocating the sub-models to different computing nodes. It is worth noting that due to the particularity of the neural network model, i.e., the hierarchical structure of the neural network model, it has significant advantages in applying model parallelism. The neural network model may be categorized into horizontal splitting and vertical splitting according to different splitting modes.

For the hybrid parallel mode, in order to overcome the defects of data parallelism and model parallelism, a hybrid parallel mode may also be set, i.e. combining the data parallel mode with the model parallel mode, so that the hybrid parallel mode may be applied to a more complex model training task.

In addition, a communication component may use cooperation between a plurality of computing nodes to accelerate completion of a training task. Due to the influence of factors such as a hardware device, a network bandwidth and a transmission rate, the communication between computing nodes of a distributed training system often becomes a bottleneck, which seriously limits the training performance. In this case, a communication component is required to design a reasonable and efficient communication mechanism, thereby reducing communication overheads. When a communication mechanism is designed, not only a restriction constraint in a hardware system level needs to be considered, but also the design problem in a software algorithm level needs to be considered. The communication component in the embodiments of the present disclosure optimizes the communication process in a distributed computing process mainly from aspects such as communication content, a communication topology and a communication synchronization manner.

In particular, the communication content relates to the parallel mode used above. In data parallelism, each compute node uses local training data for model training. In order to achieve the purpose of global model consistency, each computing node needs to communicate with other computing nodes to obtain local model parameters or updates of the other computing nodes, thereby maintaining consistency of global model parameters. Different from data parallelism, the compute nodes in the model parallel mode use the same data to train different subtasks. For example, in the training process of a neural network model, iteration of a certain computing node must rely on intermediate computing results or outputs of other nodes, and in this case, communication is required to obtain intermediate results and outputs of training of other nodes.

With regard to the communication topology, different distributed system architectures generate different communication manners, i.e. a distributed training network topology architecture determines the communication manner. Generally, a communication topology architecture of a distributed training system refers to a connection manner between computing nodes, including a physical topology and a logical topology. The physical topology mainly includes a plurality of topologies such as a Fat-Tree topology and a BCube topology. Logical topologies include a centralized architecture and a decentralized architecture.

The centralized architecture has a central master node to coordinate the various working nodes. A representative of the centralized architecture is a Parameter Server (PS) architecture. There are two roles in the PS architecture: worker and server. The former generally consists of compute nodes, while the latter generally consists of one server node or a group of server nodes. The workers are mainly responsible for the following operations: (1) completing a local training task based on a local data sample thereof; and (2) communicating with a server through a client interface, i.e. acquiring the latest global model parameter from the server and sending the local parameters thereof to the server. The server, as the core component of the PS architecture, mainly completes the following operations:
(1) aggregating the local gradients sent by the workers; and
(2) updating the global model parameter by means of ADD or SUM operations, and returning the updated global model parameter to the workers.

In addition, between the workers and a server, the PS architecture logically uses a bipartite-graph-based communication topology. In other words, communication only occurs between the server and the workers, and there is no direct communication between the workers.

The bottleneck of the centralized architecture is mainly manifested in the communication congestion problem of a central server, which is particularly prominent as the number of workers gradually increases. In order to alleviate the communication congestion problem of the server nodes of the centralized architecture, researchers propose a decentralized architecture that does not include centralized server nodes. Compared with the centralized architecture, the workers in the decentralized architecture perform information exchange therebetween by means of some intelligent communication designs, such as an All-Reduce architecture. In the All-reduce architecture, each worker needs to communicate with all workers and broadcast local information to all other workers. Therefore, each worker acquires information of all workers in this manner, thereby achieving synchronization of global information. It is worth noting that, compared to the All-Reduce, in the Gossip architecture, each worker only communicates with its neighboring workers.

In a distributed training system, implementing synchronization of information such as model parameters and gradients based on different communication topologies directly affects convergence of algorithms. Generally, a communication synchronization manner mainly includes synchronous communication and asynchronous communication, and is also referred to as a synchronization algorithm and an asynchronous algorithm.

The main idea of the synchronization algorithm is: when a computing node in the distributed training system completes the current round of iteration, it must wait for other computing nodes to complete the current round of iteration tasks, and then they may together process the next round of training iteration tasks. A specific synchronization algorithm is not limited herein, and a typical synchronization algorithm, for example, a bulk synchronous parallel (BSP) algorithm, is used as an example. In the BSP algorithm, after a certain computing node completes the current iteration task, it needs to synchronize information such as model parameters or a gradient with other computing nodes by means of different communication topology logics. They then enter the next round of iteration process with the same “start line”. To ensure that the iterations proceed with the same “start line”, the BSP algorithm introduces a global synchronization barrier. The working principle thereof is to require that computing nodes with strong processing capabilities and a high iteration speed are all forced to stop at a synchronization barrier, and wait for other computing nodes with weak processing capabilities and a low iteration speed to complete the current round of iteration tasks thereof, and then the training system executes the next round of iteration tasks.

The main idea of an asynchronous communication or an asynchronous algorithm is that after a certain computing node in a system completes the current round of iteration thereof, it may continue to execute the next round of iteration without waiting for other computing nodes. An asynchronous algorithm may be further subdivided into a multi-machine asynchronous communication and a single-machine multi-thread asynchronous communication.

Algorithm optimization components are mainly used for implementing algorithm optimization, and mainly contain the following two major classes of algorithms: (1) gradient-type optimization algorithms, including first-order optimization algorithms and higher-order optimization algorithms; (2) non-gradient-type optimization algorithms. Specifically, first-order optimization algorithms mainly include gradient descent (GD), stochastic gradient descent (SGD), mini-batch stochastic gradient descent, projected sub-gradient (PSG) method, and the like. Second-order optimization algorithms mainly include a Newton method, a quasi-Newton method, and the like. Non-gradient-type optimization algorithms mainly include a coordinate descent method (CDM), a primary dual method, and the like.

An aggregation component aggregates the intermediate results generated by the computing nodes, so as to output final training results. An effective aggregation method will accelerate the training process. In general, an aggregation component may include a summation-based aggregation and an integration-based aggregation.

A summation-based aggregation method is commonly found in a data parallel mode, and after all computing nodes complete their own training tasks, an aggregation component aggregates intermediate results generated by the computing nodes based on a specific aggregation logic. The aggregation logic generally includes full aggregation and partial aggregation. The foregoing two types of aggregation logics are described below by using a parameter server architecture. The full aggregation logic assigns different weights to different computing nodes, and calculates a weighted sum of the intermediate results generated by all the computing nodes. The advantages of full aggregation are low computation complexity and ease of implementation, and the disadvantage of full aggregation is that the algorithm tends to generate “trailer” effects in situations where a synchronous parallel algorithm framework is used. In order to overcome the insufficiency of full aggregation, researchers propose partial aggregation logics, including a synchronous algorithm with a backup node, an asynchronous ADMM (Alternating Direction Method of Multipliers) algorithm, and a decentralization algorithm. The synchronization algorithm with a backup node adopts the strategy of trading space for time. For example, aggregating intermediate results of an additional about 5% of the computing nodes may effectively improve the accuracy of the algorithm. Asynchronous ADMM controls the maximum latency to aggregate intermediate results of some of the computing nodes, thereby avoiding learning imprecise information of “trailer” computing nodes. The decentralization algorithm aggregates intermediate results of a small number of neighbor nodes.

The integration-based aggregation may then be used to solve the aggregation problem of non-convex neural network model training. For example, studies have pointed out that simply averaging local intermediate results of computing nodes may not ensure that the performance of a global model is superior to that of a local model. Thus, a fusion compression method, EC-DNN (Deep Neural Networks), may be used. In addition, voting-based aggregation plays an important role. Compared with the single-machine training, the algorithm ensures quick convergence of the model training process on the premise of almost losing no precision.

The embodiments of the present disclosure, by means of an effective distributed algorithm design, exploit factors affecting deep learning model training, explore a deep-level built-in association between a distributed architecture, a communication mode and gradient calculation, establish an accurate and reliable distributed accelerated calculation rule, narrow down a subtask training space, reduce model training time, and may effectively improve the model training accuracy, and reduce the storage overhead of gradient and model parameter variables.

Some embodiments of the present disclosure further provide is a non-transitory computer-readable storage medium, wherein the non-transitory computer-readable storage medium stores a computer program, and the computer program, when executed, may implement the operations provided in the embodiments. The storage medium may include any medium that may store program code, such as a USB flash disk, a portable hard disk, a Read-Only Memory (ROM), a Random Access Memory (RAM), a magnetic disk, or an optical disk.

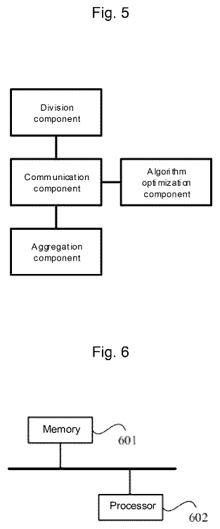

Some embodiments of the present disclosure further provide a server (which may also be another distributed computing device). Referring to FIG. 6, the server may include a memory 601 and a processor 602. The memory 601 stores a computer program. When the processor 602 invokes the computer program in the memory 601, the operations provided in the foregoing embodiments may be implemented. Of course, the server (which may also be another distributed computing device) may further include various components such as a network interface and a power supply.

The embodiments in the present description are described in a progressive manner. Each embodiment focuses on a different from other embodiments, and reference may be made to each other for the same or similar parts of the embodiments. For the system provided in the embodiments, as it corresponds to the method provided in the embodiments, the description thereof is relatively brief, and for related parts, reference may be made to the description in the method part.

The principle and implementation of the present disclosure are described herein through specific examples, and the description of the embodiments above is only used to assist in the understanding of the method of the present disclosure and its main idea. It should be noted that for a person having ordinary skill in the art, one or more improvements and modifications may be made to the present disclosure without departing from the principle of the present disclosure, and these improvements and modifications also fall within the scope of protection of the claims of the present disclosure.

It should be noted that in the present description, relational terms such as first and second are used to only distinguish one entity or operation from another entity or operation, without necessarily requiring or implying any such actual relationship or sequence between these entities or operations. Furthermore, the terms “include”, “including”, or any other variations thereof are intended to cover a non-exclusive inclusion, so that a process, a method, an article, or a device that includes a series of elements not only includes those elements, but also includes other elements that are not explicitly listed, or may further include inherent elements of the process, the method, the article, or the device. Without further limitation, an element defined by a sentence “including a . . . ” does not exclude the presence of other same elements in a process, a method, an article, or a device that includes the element.

1. A distributed computing method, comprising:
acquiring a data computing task;
splitting the data computing task to obtain subtasks, deploying the subtasks to computing nodes, and configuring a parallel mode for each of the computing nodes in a distributed training universal frame;
configuring a connection manner and a communication synchronization manner between the computing nodes;
optimizing information synchronization efficiency for the computing nodes by using a gradient optimization algorithm or a non-gradient optimization algorithm; and
aggregating intermediate results generated by the computing nodes, and outputting a final computing result corresponding to the data computing task.

2. The distributed computing method according to claim 1, wherein the parallel mode comprises a data parallel mode, a model parallel mode, and a hybrid parallel mode, wherein the data parallel mode comprises sample-based data parallelism and sample dimension-based data parallelism.

3. The distributed computing method according to claim 2, wherein when the sample-based data parallelism is adopted, deploying the subtasks to the computing nodes comprises:
deploying each of the subtasks to the computing nodes by means of random sampling with replacement and local shuffling sampling.

4. The distributed computing method according to claim 2, wherein when the sample dimension-based data parallel is adopted, and the subtasks comprise one or more dimensions of attributes or features, deploying the subtasks to the computing nodes comprises:
dividing the subtasks according to the attributes or the features to obtain task samples; and
allocating the task samples to the computing nodes corresponding to the task samples.

5. The distributed computing method according to claim 2, wherein when the parallel mode is the model parallel mode, the method further comprises:
horizontally splitting a distributed computing model or vertically splitting a distributed computing model to adapt to the subtasks.

6. The distributed computing method according to claim 1, wherein:
configuring the connection manner and the communication synchronization manner between the computing nodes comprises:
determining whether the data computing task comprises a specified connection manner;
constructing a distributed computing system in the specified connection manner when the data computing task comprises the specified connection manner, wherein the specified connection manner comprises either a centralized architecture or a decentralized architecture; and
parsing the data computing task to obtain the communication synchronization manner, and configuring the communication synchronization manner between nodes in the distributed computing system according to the communication synchronization manner.

7. The distributed computing method according to claim 6, wherein when the specified connection manner is a centralized architecture, constructing the distributed computing system in the specified connection manner comprises:
determining workers consisting of the computing nodes and a server consisting of one or a group of server nodes; wherein,
the workers are used for completing a local training task, communicating with the server through a client interface so as to acquire a latest global model parameter, and sending local parameters of the workers to the server; and the server is used for aggregating the local parameters sent by each of the workers, and updating the global model parameter by using ADD or SUM operations.

8. The distributed computing method according to claim 6, wherein when the specified connection manner is a decentralized architecture, constructing the distributed computing system in the specified connection manner comprises:
determining workers consisting of the computing nodes;
wherein information exchange between the workers is performed by using a Reduce architecture or a Gossip architecture, and the distributed computing system is constructed by using the Reduce architecture or the Gossip architecture.

9. The distributed computing method according to claim 8, wherein when the distributed computing system adopts the Reduce architecture, each of the workers communicates with all other workers comprised in the workers and transmits local information to all the other workers in a broadcast manner.

10. The distributed computing method according to claim 8, wherein when the distributed computing system adopts the Gossip architecture, each of the workers communicates with its neighboring workers comprised in the workers.

11. The distributed computing method according to claim 6, wherein when the communication synchronization manner is synchronous communication, configuring the communication synchronization manner between the nodes in the distributed computing system according to the communication synchronization manner comprises:
configuring the communication synchronization manner between the nodes in the distributed computing system according to synchronous communication, wherein when any computing node in the distributed training system completes the current round of iteration, after waiting for other computing nodes to complete the current round of iteration tasks corresponding to the other computing nodes, all the computing nodes start to process the next round of training iteration tasks.

12. The distributed computing method according to claim 6, wherein when the communication synchronization manner is asynchronous communication, configuring the communication synchronization manner between the nodes in the distributed computing system according to the communication synchronization manner comprises:
configuring the communication synchronization manner between the nodes in the distributed computing system according to asynchronous communication, wherein when any computing node in the distributed training system completes the current round of iteration, the computing node continues to process the next round of training iteration tasks.

13. The distributed computing method according to claim 1, wherein aggregating the intermediate results generated by the computing nodes, and outputting the final computing result corresponding to the data computing task comprises:
aggregating, by using an ADD-SUM aggregation logic or an integrated aggregation logic, the intermediate results generated by the computing nodes, and outputting the final computing result corresponding to the data computing task,
wherein the ADD-SUM aggregation comprises a full aggregation logic and a partial aggregation logic, the full aggregation logic is used for assigning different weights to different computing nodes, and calculating a weighted sum of the intermediate results generated by all the computing nodes.

14. The distributed computing method according to claim 1, wherein the data computing task is a data computing task sent by a cloud or another distributed computing device and received via a network or a data link.

15. The distributed computing method according to claim 5, wherein the distributed computing model comprises a neural network model.

16. The distributed computing method according to claim 1, wherein the connection manner between the computing nodes comprises a communication topology architecture of the computing nodes in the distributed computing system, and a communication manner between the computing nodes in the communication topology architecture.

17. The distributed computing method according to claim 6, wherein the method further comprises:
when the data computing task does not comprise a specified connection manner, the connection manner between the computing nodes is configured in a default connection manner.

18. (canceled)

19. A non-transitory computer-readable storage medium, wherein the non-transitory computer-readable storage medium stores a computer program, wherein the computer program, when executed by a processor, implements the following operations:
acquiring a data computing task;
splitting the data computing task to obtain subtasks, deploying the subtasks to computing nodes, and configuring a parallel mode for each of the computing nodes in a distributed training universal frame;
configuring a connection manner and a communication synchronization manner between the computing nodes;
optimizing information synchronization efficiency for the computing nodes by using a gradient optimization algorithm or a non-gradient optimization algorithm; and
aggregating intermediate results generated by the computing nodes, and outputting a final computing result corresponding to the data computing task.

20. A distributed computing device, comprising a memory and a processor, wherein the memory stores a computer program, and when the processor invokes the computer program in the memory, the following operations are implemented:
acquiring a data computing task;
splitting the data computing task to obtain subtasks, deploying the subtasks to computing nodes, and configuring a parallel mode for each of the computing nodes in a distributed training universal frame;
configuring a connection manner and a communication synchronization manner between the computing nodes;
optimizing information synchronization efficiency for the computing nodes by using a gradient optimization algorithm or a non-gradient optimization algorithm; and
aggregating intermediate results generated by the computing nodes, and outputting a final computing result corresponding to the data computing task.

21. The non-transitory computer-readable storage medium according to claim 19, wherein configuring the connection manner and the communication synchronization manner between the computing nodes comprises:
determining whether the data computing task comprises a specified connection manner;
constructing a distributed computing system in the specified connection manner when the data computing task comprises the specified connection manner, wherein the specified connection manner comprises either a centralized architecture or a decentralized architecture; and
parsing the data computing task to obtain the communication synchronization manner, and configuring the communication synchronization manner between nodes in the distributed computing system according to the communication synchronization manner.
